(19) United States
(12) Patent Application Publication
(10) Pub. No.: US 2006/0233929 A1
(43) Pub. Date: Oct. 19, 2006

(54) Dough proofer with chill and retard functions and related methods

(76) Inventors: Joseph F. Sanders, North Richland Hills, TX (US); Walter J. Boryca, Keller, TX (US); Jackson M. Miles JR., Weatherford, TX (US)

Correspondence Address: THOMPSON HINE LLP, P.O Box 8801, DAYTON, OH, 45401-8801, US

(21) Appl. No.: 11/107,193

(22) Filed: Apr. 15, 2005

(51) Int. Cl. A21D 6/00

(52) U.S. Cl. 426/496

(57) ABSTRACT

A dough proofing cabinet includes both a heating capability and a cooling capability. The device may be operated to provide a proof/chill/retard cycle for dough.

### TECHNICAL FIELD

The present application relates generally to cabinets utilized for proofing dough (i.e., allowing the dough to rise), and more particularly to a dough proofing cabinet with that also functions with chiller and retarder features.

### BACKGROUND

Restaurant and other food service operations that proof dough on site have traditionally used multiple units to properly handle the dough at all stages. For example, unproofed dough is commonly stored in a walk-in type refrigeration room. The dough may be moved from the walk-in refrigerator and placed in a dough proofing cabinet for proofing. Once the dough proofing cycle is completed the dough may be relocated to a separate retarder cabinet where the proofed dough is held until retrieved for use. In some cases, between the proofer and the retarder the dough may be placed into a separate chiller that quickly brings the temperature of the proofed dough down below forty degrees Fahrenheit. It would be advantageous to provide a dough proofer that facilitates a reduction in the number of units required in a food service setting where dough is proofed on site.

### SUMMARY

In one aspect, a dough proofing apparatus includes a chamber for holding dough and a door for accessing the chamber. At least one blower is located for causing airflow from the chamber and along at least one flow path. Both a heater and a cooling system are provided. A controller is operatively connected with each of the blower, the heater and the cooling system to carry out the following steps: (a) operate the apparatus for dough refrigeration within the chamber; (b) subsequent to step (a), operate the apparatus for dough proofing within the chamber; (c) subsequent to step (b), operate the apparatus for dough chilling within the chamber; and (d) subsequent to step (c), operate the apparatus for dough retarding within the chamber.

### BRIEF DESCRIPTION OF THE DRAWINGS

FIG. 1 is a side elevation of a dough proofer;

FIG. 2 is a top plan along line 2-2- of FIG. 1;

FIG. 3 is a schematic of a cooling system of the proofer;

FIG. 4 is a combined table and chamber temperature vs. time graph, where the operating modes of the proofer are aligned with the time axis of the graph;

FIG. 5 is a schematic of an exemplary control arrangement for the proofer.

### DETAILED DESCRIPTION

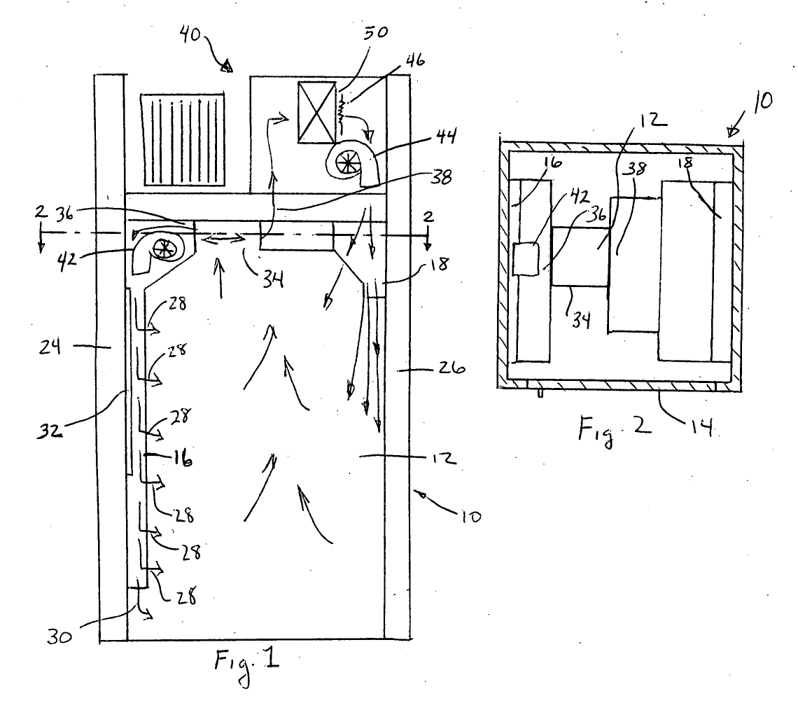

Referring to FIGS. 1-2, a proofer 10 includes a proofing chamber 12 and a door or doors 14 that provide access to the chamber 12 for permitting a rack of dough products to be moved into and out of the chamber 12. The chamber 12 may be sized to receive a single rack or multiple racks. Air duct 16 extends downward along one side of the chamber 12. Air duct 18 is located on an opposite side of the chamber 12. The ducts 16 and 18 may be formed by one or more u-shaped panels affixed to the insulated side walls 24 and 26 of the proofer box. Air duct 16 includes a plurality of openings that may be distributed both vertically and horizontally in the chamber 12 allowing airflow therethrough as shown by arrows 28 and may also include an opening at the bottom permitting airflow as depicted by arrow 30. Duct 18 is open at the bottom to provide airflow at the opposite side of the chamber 12. While the illustrated embodiment provides a single air duct on each side of the chamber, multiple air ducts on each side of the chamber (such as multiple ducts side by side along the depth of the unit) could be utilized.

A heating element 32, which may take the form of a resistive-type heating rod, is located in the duct 16 for heating the airflow therein when energized. An upper part of the chamber includes at least one outlet opening 34, which may be covered by a screen, that communicates with a flow path 36 leading to duct 16 and a flow path 38 that communicates with duct 18 via a cooling system 40 atop the unit. It is contemplated that opening 34 could be located elsewhere, such as in a rear wall or panel of the box. Blower 42 is located to cause airflow along the first flow path 36 and into the duct 16. Blower 44, which may be the evaporator blower, is located for causing airflow along flow path 38, through the cooling system, and into duct 18. An evaporator defrost heating element 46 is also included.

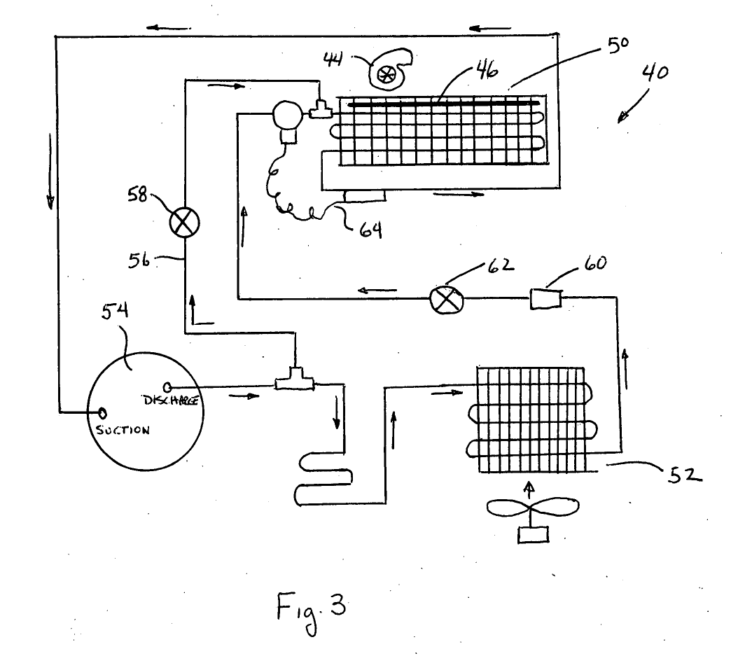

Referring now to FIG. 3, a schematic of the cooling system 40 is provided, showing evaporator 50, forced air condenser 52, and compressor 54, with arrows depicting the flow of fluid in the system. Notably, at the discharge or output side of the compressor 54, a hot gas bypass line 56 is provided for permitting fluid to bypass the condenser 52. A solenoid valve 58 or other flow control device is connected in the bypass line 56 for selectively controlling the flow of hot gas from the compressor output to the evaporator. A drier 60 is connected downstream of the condenser 52 and a liquid line solenoid valve 62 or other flow control device is connected downstream of the drier. Thermal expansion valve 64 is also shown for metering flow into the evaporator.

Utilizing the above-described proofer, a basic method for handling an unproofed dough product can be achieved. Specifically, (a) an operator places unproofed dough in the chamber 12; (b) the unit is operated in a refrigeration mode to keep the unproofed dough cool enough to prevent the dough from rising; (c) subsequent to step (b), the unit is operated in a proofing mode during which temperature of the unproofed dough is raised to allow the unproofed dough to rise, resulting in proofed dough; (d) subsequent to step (c), the unit is operated in a chilling mode during which the proofed dough is cooled; and (e) subsequent to step (d), the unit is operated in a retarding mode during which the proofed dough is kept cool so as to limit further dough rising. Thus, the proofer 10 advantageously combines proof, chill and retard features into a single unit. In one example, operation of the unit during the refrigeration mode and the retard mode may be the same.

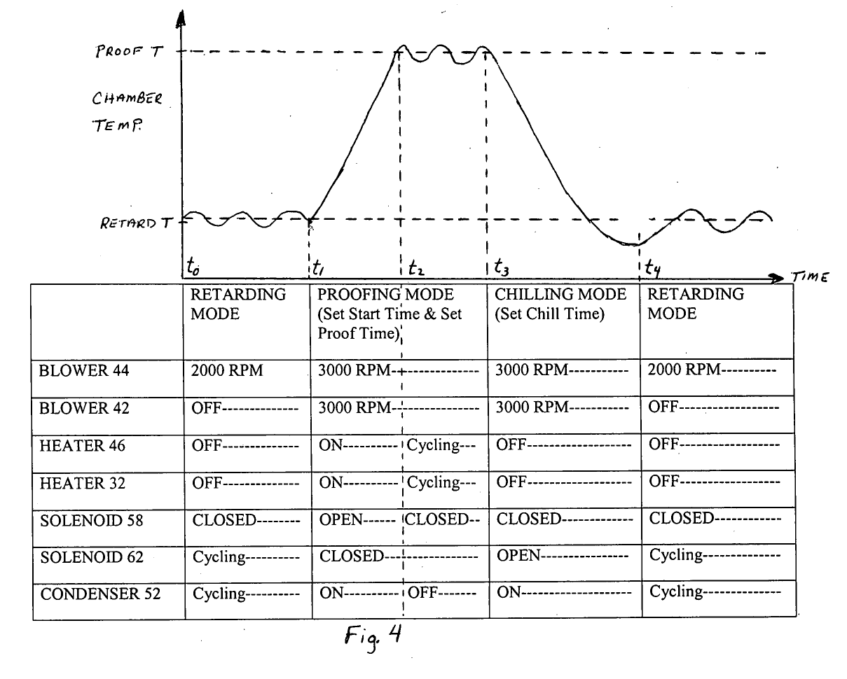

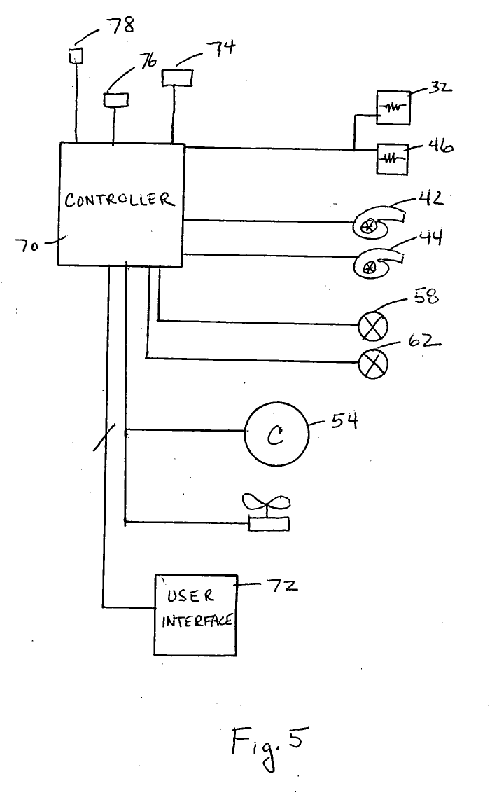

FIG. 4 shows a combined table and chamber temperature vs. time graph, where the operating modes of the proofer are aligned with the time axis of the graph. Operating functions for the blower 33, blower 42, heater 46, heater 32, solenoid valve 58, solenoid valve 62 and condenser 52 are shown in the table, and the graph depicts the resulting temperature condition in the chamber. In FIG. 4 the refrigeration mode and retarding mode mentioned above are identical, and therefore both are called the retarding mode.

During the retarding mode (from time t₀ to t₁): the blower 44 is operated at 2000 RPM (which in one example, where a volume of the proofer chamber is about 30 to 40 cubic feet, such as 35 to 37 cubic feet, results in 375 CFM airflow at a 0.2″ water column); blower 42 is maintained OFF, heater 46 is maintained OFF, heater 32 is maintained OFF, solenoid 58 is maintained CLOSED; and solenoid 62 cycles between OPEN and CLOSED conditions and condenser 52 cycles between ON and OFF conditions as is normal for cooling systems in refrigerators/freezers. When closed, solenoid 62 prevents fluid flow from the condenser to the evaporator. During condenser unit cycling both the compressor and the condenser fan may be turned ON and OFF together. As seen in the graph, the temperature of the proofer chamber is maintained at or around a retard temperature (RETARD T), which might typically be between about 35° F. and 40° F., such as 37° F.

At time t₁ the proofing mode is initiated. In this regard, a controller of the proofer may include a timer for automatically initiating the proofing mode at time t₁. Specifically, the timer may have a clock function that is set to the applicable time of the location where the proofer is functioning. When the operator places dough in the chamber of the unit the operator utilizes a user interface of the unit to initiate a “retard/proof/chill/retard cycle”. In one example, the controller is configured such that during a retard/proof/chill/retard cycle the controller automatically transitions from the retarding mode to the proofing mode at a set time (such as between 12:00 AM and 6:00 AM or between 2:00 AM and 4:00 AM). The proofing mode start time may be adjustable via the user interface of the unit. In this manner proofing can take place automatically during the night so that dough is ready for use in the morning when workers arrive. The unit may also permit the proofing mode to be initiated on command via a user interface. The proofing mode (from time t₁ to t₃) may last for a set time period (such as between about 45 and 85 minutes or between about 55 and 75 minutes). The proof time may be adjustable via the user interface of the unit. As shown in FIG. 4, during the proofing mode both blowers 42 and 44, which may be similarly sized, are operated at 3000 RPM and the solenoid valved 62 is maintained CLOSED. During an initial portion of the proofing mode (t₁ to t₂) the heaters 46 and 32 are both turned ON, the solenoid valve 58 is OPEN and the condenser 52 is turned ON (meaning the compressor is ON). Opening of valve 58 allows hot gas to flow from the output side if the compressor directly to the evaporator, bypassing the condenser, so that the hot gas assists in bringing up the temperature of the evaporator. This feature is particularly useful where airflow in the unit is split between two paths, only one of which flows by the evaporator. At time t₂, when the desired proofing temperature (PROOF T) has been reached, the solenoid valve 58 is CLOSED, the condenser 52 is turned OFF and the heaters 46 and 32 are cycled as needed to maintain the chamber temperature at or around the proofing temperature. The proofing temperature may be in the range of about 70° F. to 110° F., or in the range of about 85° F. to 95° F.

Upon completion of the proofing mode, at time t₃, the chilling mode is initiated. During the chilling mode, both blowers 44 and 42 are operated at 3000 RPM, heaters 46 and 32 are maintained OFF, solenoid 58 remains CLOSED, solenoid 62 is maintained OPEN and condenser 52 is maintained ON. The goal of the chilling mode is to bring the temperature of the proofed dough product down fairly quickly. The duration of the proofing mode (t₃ to t₄) may be a set time (such as about 60 to 120 minutes or about 80 to 100 minutes) and may be adjustable via the user interface of the unit. Alternatively, the chilling mode may continue until a desired temperature condition is reached (such as when the chamber temperature drops to the retarding temperature (RETARD T) or, in a more advanced system, where the actual temperature of the proofed dough product, as monitored by a probe, reaches a certain temperature or where a simulated temperature of the proofed dough product reaches a certain temperature. As shown in FIG. 4, during the chilling mode the cabinet temperature may actually drop well below the retarding temperature (e.g, about 8 to 12° F. less than the retarding temperature) in order to more quickly bring down the temperature of the proofed dough product. However, in another embodiment the chilling mode may be embodied by running the compressor continuously until the cabinet temperature drops to the retard temperature (RETARD T), at which point the condenser would begin cycling as during a normal retard operation. In such case the chilling operation or chilling mode may simply be embodied by the initial portion of a retarding mode that follows the proofing mode.

Upon completion of the chilling mode, at time t₄, the retarding mode is again initiated. A defrost mode or cycle, not shown, may be entered during the retarding mode, during which the solenoid 62 would be closed and the condenser 52 turned OFF. The defrost mode may be initiated on a time basis (e.g, every 4 hours) or some other basis such as a monitored parameter or parameters of the unit. However, the defrost function should preferably be disabled during both the proofing mode and chilling mode.

Referring now to FIG. 5, a schematic control system arrangement is shown, with controller 70 connected to control each of the heaters 32 and 46, the blowers 42 and 44, the valves 58 and 62, and the compressor 54 and condenser fan. In one example, the heaters 32 and 46 are controlled by a common output from a microprocessor or microcontroller. In such an arrangement the hot gas bypass line may be used for defrost cycles of the evaporator. The compressor 54 and condenser fan may also be controlled by a common output. The controller 70 is also connected to a user interface 72, which may take various forms such as a touch screen display or a more basic display and a related collection of buttons and/or switches and/or dials. A temperature sensor 74 for monitoring temperature within the chamber is also shown, as well as a sensor 76 that monitors for an open condition of the door of the unit. An evaporator coil temperature sensor 78 is also shown, which may be used to trigger initiation and/or termination of defrost operations.

The cooling system 40 may be sized as necessary to achieved desired chilling operations. In one example the cooling system may be sized at ¾ horsepower.

It is to be clearly understood that the above description is intended by way of illustration and example only and is not intended to be taken by way of limitation. For example, while the illustrated embodiment does not contain any humidity controls, a source of water could be provided for such purpose, along with a humidity sensor. As another example, while the illustrated embodiment describes a heating element in the nature of an energizable, resistive heating element, in other embodiments non-electric heating elements could be used, such as a combustion type heat exchanger. Other changes and modifications could be made, including both narrowing and broadening variations of the previously described embodiments.

What is claimed is:

1. A dough proofing apparatus, comprising:
a chamber for holding dough;
a door for accessing the chamber;
at least one blower located for causing airflow from the chamber and along at least one flow path;
a heater;
a cooling system;
a controller operatively connected with each of the blower, the heater and the cooling system to carry out the following steps:
(a) operate the apparatus in a refrigeration mode;
(b) subsequent to the refrigeration mode, operate the apparatus in a proofing mode;
(c) subsequent to the proofing mode, operate the apparatus in a chilling mode; and
(d) subsequent to the chilling mode, operate the apparatus in a retarding mode.

2. The dough proofing apparatus of claim 1 wherein the controller includes a timer and:
initiation of step (b) occurs at a specified time;
initiation of step (c) occurs when the proofing mode has continued for a set time period.

3. The dough proofing apparatus of claim 2 wherein initiation of step (d) occurs when the chilling mode has continued for a set time period.

4. The dough proofing apparatus of claim 2 wherein initiation of step (d) occurs when a certain temperature condition is reached.

5. The dough proofing apparatus of claim 2 wherein the specified time is between 12:00 AM and 6:00 AM.

6. The dough proofing apparatus of claim 1 wherein the cooling system includes a hot gas bypass line between an output side of a compressor and an input side of an evaporator for enabling bypass of a condenser, a flow control device positioned for controlling flow along the hot gas bypass line, the controller connected with the flow control device, wherein step (b) involves controlling the flow control device to permit flow along the hot gas bypass line in order to increase temperature of the evaporator.

7. The dough proofing apparatus of claim 6 wherein in step (b) the flow control device is controlled to permit flow along the hot gas bypass line until temperature within the chamber reaches a certain temperature, at which point the flow control device is controlled to prevent further flow along the hot gas bypass line.

8. The dough proofing apparatus of claim 7 wherein the certain temperature is at least 80° F.

9. The dough proofing apparatus of claim 1, further comprising:
a first air duct for delivering air to a first side of the chamber;
a second air duct for delivering air to a second side of the chamber;
an upper opening in the chamber;
the at least one flow path includes a first flow path leading from the upper opening to the first air duct and a second flow path leading from the upper opening to the second air duct;
the heater is located to heat air that follows the first flow path, the heater energized during step (b);
the cooling system is located along the second flow path and includes a defrost heater that is energized in step (b).

10. The dough proofing apparatus of claim 9 wherein the at least one blower includes a first blower that when operated causes airflow along the first flow path and a second blower that when operated causes airflow along the second flow path.

11. A dough proofing apparatus, comprising:
a chamber for holding dough;
a door for accessing the chamber;
at least one blower located for causing airflow from the chamber and along at least one flow path;
a heater;
a cooling system;
a controller operatively connected with each of the blower, the heater and the cooling system to carry out the following steps:
(a) operate the apparatus for dough refrigeration within the chamber;
(b) subsequent to step (a), operate the apparatus for dough proofing within the chamber;
(c) subsequent to step (b), operate the apparatus for dough chilling within the chamber; and
(d) subsequent to step (c), operate the apparatus for dough retarding within the chamber.

12. The dough proofing apparatus of claim 11 wherein:
step (a) involves cyclically operating the cooling system to maintain chamber temperature at or about a temperature that is less than 40° F.;
step (b) involves turning off the cooling system and operating the heater to raise chamber temperature to a temperature of at least 80° F.;
step (c) involves turning off the heater and turning on the cooling system to lower chamber temperature to a temperature that is less than 40° F.;
step (d) involves cyclically operating the cooling system to maintain chamber temperature at or about a temperature that is less than 40° F.

13. The dough proofing apparatus of claim 11 wherein the cooling system includes a hot gas bypass line between an output side of a compressor and an input side of an evaporator for enabling bypass of a condenser, a flow control device positioned for controlling flow along the hot gas bypass line, the controller connected with the flow control device, wherein step (b) involves controlling the flow control device to permit flow along the hot gas bypass line in order to increase temperature of the evaporator.

14. The dough proofing apparatus of claim 13 wherein in step (b) the flow control device is controlled to permit flow along the hot gas bypass line until chamber temperature reaches a certain temperature, at which point the flow control device is controlled to prevent further flow along the hot gas bypass line.

15. A method for proofing dough, comprising:
(a) placing unproofed dough in a chamber of a proofing apparatus, the proofing apparatus includes both a heating capability and a cooling capability;
(b) controlling cabinet temperature so as to keep the unproofed dough cool;
(c) subsequent to step (b), controlling cabinet temperature so as to allow the unproofed dough to rise, resulting in proofed dough;
(d) subsequent to step (c), controlling cabinet temperature to chill the proofed dough;
(e) controlling cabinet temperature so as to limit further rising of the proofed dough.

16. The method of claim 15 wherein step (c) is initiated by a controller of the apparatus at a set time.

17. The method of claim 16 wherein step (c) continues for a set time period.

18. The method of claim 16 wherein step (c) continues until a temperature condition is reached.

19. The method of claim 17 wherein step (d) continues for a set time period.

20. The method of claim 16 wherein the set time is between about 12:00 AM and 6:00 AM in a time zone where the apparatus is located.

21. The method of claim 15 wherein the cooling capability of the apparatus is provided by a cooling system that includes a hot gas bypass line between an output side of a compressor and an input side of an evaporator for enabling bypass of a condenser, step (c) includes permitting flow along the hot gas bypass line in order to increase temperature of the evaporator.

22. The method of claim 21 wherein in step (c) flow along the hot gas bypass line is stopped when temperature within the chamber reaches a certain temperature.

23. The method of claim 22 wherein the certain temperature is a proofing temperature for step (c).
